(19) United States
(12) Patent Application Publication
(10) Pub. No.: US 2024/0239419 A1
(43) Pub. Date: Jul. 18, 2024

(54) Accessory Mounting System

(71) Applicant: Leer Group, Elkhart, IN (US)

(72) Inventors: Eugene A. Dylewski, II, Granger, IN (US); Ian E. Dill, South Bend, IN (US)

(21) Appl. No.: 18/411,181

(22) Filed: Jan. 12, 2024

Related U.S. Application Data
(60) Provisional application No. 63/439,388, filed on Jan. 17, 2023.

(51) Int. Cl. B62D 33/023; B60J 7/16

(52) U.S. Cl. CPC B62D 33/023; B60J 7/1607

(57) ABSTRACT

An accessory mounting system is provided. The accessory mounting system supports an accessory, such as a truck bed cap, on a truck bed sidewall. The accessory mounting system includes at least one support block configured to be positioned within a pocket in a sidewall cap of the truck bed sidewall and extend from a top surface of the truck bed sidewall located under the sidewall cap; and the at least one support block includes a top surface configured to support the accessory and a bottom surface that is configured to be supported by the truck bed sidewall.

### RELATED APPLICATIONS

The present Application relates to and claims priority to U.S. Provisional Patent Application, Ser. No. 63/439,388, filed on Jan. 17, 2023, entitled “Cap Mounting System.” The subject matter disclosed in that Provisional Application is hereby expressly incorporated into the present Application.

### TECHNICAL FIELD AND SUMMARY

The present disclosure relates to trucks, such as pickup trucks and like vehicles, with truck beds or cargo boxes installed thereon. In particular, the present disclosure relates to an accessory mounting system for a truck bed or cargo box.

A truck bed or cargo box is a large open space of a pickup truck located behind the truck's cab section. The cargo box is typically composed of a floor bounded by opposing sidewalls. A bulkhead extends between the opposed sidewalls and is located adjacent the cab section. A tailgate is located opposite the bulkhead at the rear end of the cargo box and is movable between open and closed positions.

A truck bed cap is an enclosure that attaches to the top sidewalls of a pickup truck's cargo box or truck bed. The truck cap includes upward extending side and forward walls, and a door typically positioned at the rearward end above the truck bed's tailgate (although the door can be placed anywhere on the cap). Typically, the upward extending walls terminate at the approximate height of the pickup truck's cab section roof. This configuration enhances the pickup truck's aesthetic appearance similar to a sport utility vehicle (SUV).

A typical sidewall for a cargo box may compose multiple formed sheets of metal, illustratively, including an outer sheet, inside sidewall sheet, and an inside sidewall rail. Such sidewalls may include more or less formed sheets of metal. Also, a common feature on cargo box sidewalls is a top sidewall cap, often made of plastic, or like material. The sidewall cap fits on top of the top surface of the sidewall.

In certain instances, the sidewall cap is positioned over the top of the cargo box sidewall such that a space or gap exists between the underside of the plastic sidewall cap and the top surface of the sidewall itself. In such circumstances, an issue may arise with the structural integrity of the sidewall cap when certain accessories, such as a truck bed cap, are placed on the sidewalls. The weight of the truck bed cap may be too great for the sidewall cap to support.

Accordingly, an illustrative embodiment of the present disclosure provides an accessory mounting system. The accessory mounting system supports an accessory on a truck bed sidewall. The accessory mounting system includes at least one support block configured to be positioned within a pocket in a sidewall cap of the truck bed sidewall and extend from a top surface of the truck bed sidewall located under the sidewall cap; the at least one support block includes a top surface configured to support the accessory and a bottom surface configured to be supported by the truck bed sidewall; the top surface of the at least one support block is configured to extend above a top surface of the sidewall cap to create a gap between the accessory and the top surface of the sidewall cap so the accessory is configured to be supported by the at least one support block and not the sidewall cap; a bore disposed through the at least one support block; and a fastener, wherein the bore is configured to receive the fastener to secure the at least one support block to the truck bed sidewall.

In the above and other embodiments, the accessory mounting system may further comprise: the at least one support block having a plurality of support blocks, wherein each of the plurality of support blocks is configured to be positioned in one pocket; the each of the plurality of support blocks having a top surface configured to support the accessory and a bottom surface that is configured to be supported by the truck bed sidewall; the each of the plurality of support blocks includes a top surface configured to support the accessory and a bottom surface configured to be supported by the truck bed sidewall or by a second truck bed sidewall spaced apart from the truck bed sidewall; the each of the plurality of support blocks is configured to extend above the top surface of the sidewall cap to create a gap between the accessory and the top surface of the sidewall cap so the accessory is configured to be supported by the each of the plurality of support blocks and not the sidewall cap; the each of the plurality of support blocks is configured to extend above the top surface of the sidewall cap of the truck bed sidewall or above a second sidewall cap of the second truck bed sidewall to create a gap between the accessory and the top surface of the sidewall cap or a top surface of the second sidewall cap so the accessory is configured to be supported by the each of the plurality of support blocks and not by the sidewall cap or the second sidewall cap; the each of the plurality of support blocks includes a bore disposed therethrough; the each of the plurality of support blocks receives a fastener to secure the each of the plurality of support blocks to the truck bed sidewall; at least one seal configured to be positioned in the gap between the accessory and the top surface of the sidewall cap; the at least one seal includes a plurality of seals; and the fastener is a bolt.

Another illustrative embodiment of the present disclosure provides an accessory mounting system. The accessory mounting system supports an accessory on a truck bed sidewall. The accessory mounting system includes at least one support block configured to be positioned within a pocket in a sidewall cap of the truck bed sidewall and extend from a top surface of the truck bed sidewall located under the sidewall cap; and wherein the at least one support block includes a top surface configured to support the accessory and a bottom surface that is configured to be supported by the truck bed sidewall.

In the above and other embodiments, the accessory mounting system may further comprise: the top surface of the at least one support block being configured to extend above a top surface of the sidewall cap to create a gap between the accessory and the top surface of the sidewall cap; a bore is disposed through the at least one support block; a fastener, wherein the bore is configured to receive the fastener to secure the at least one support block to the truck bed sidewall; the fastener being a bolt; the at least one support block having a plurality of support blocks, wherein each of the plurality of support blocks is configured to be positioned in one pocket; and the each of the plurality of support blocks having a top surface configured to support the accessory and a bottom surface configured to be supported by the truck bed sidewall.

Additional features of the accessory mounting system will become apparent to those skilled in the art upon consideration of illustrative embodiments of carrying out the cap mounting system as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective detail view of a portion of a cargo box sidewall;

FIG. 2 is a cross-sectional end detail view of a portion of the cargo box sidewall;

FIG. 3 is a cross-sectional exploded end detail view of a portion of the cargo box sidewall;

FIG. 4 is a perspective exploded detail view of a portion of the cargo box sidewall;

FIG. 5 is a perspective exploded detail view of a portion of the cargo box sidewall with an accessory support mounting system;

FIG. 6 is another perspective detail view of a portion of a cargo box sidewall with the accessory support mounting system installed thereon;

FIG. 7 is a cross-sectional end detail view of a portion of the cargo box sidewall with the accessory support mounting system installed thereon;

FIG. 8 is a perspective exploded detail view of a portion of the cargo box sidewall with the accessory support mounting system;

FIG. 9 is a cross-sectional end detail view of a portion of the cargo box sidewall;

FIG. 10 is another cross-sectional end detail view of a portion of the cargo box sidewall with the accessory support mounting system;

FIG. 11 is a perspective detail view of a portion of the cargo box sidewall with the accessory support mounting system;

FIG. 12 is a cross-sectional exploded end detail view of a portion of the cargo box sidewall with the accessory support mounting system; and

FIG. 13 is a perspective view of an illustrative truck cap.

Corresponding reference characters indicate corresponding parts throughout the several views. The exemplification set out herein illustrates embodiments of the accessory mounting system, and such exemplification is not to be construed as limiting the scope of the accessory mounting system in any manner.

### DISCLOSURE OF ILLUSTRATIVE EMBODIMENTS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a cap or accessory mounting system that allows a truck bed or cargo box cap or accessory to be placed onto the cargo box sidewalls with sidewall caps having insufficient structural strength to support the weight of the truck bed cap or accessory. In an illustrative embodiment, a support block may be positioned within an opening or pocket in the sidewall cap and extend downward to the top surface of the cargo box sidewall.

Typically, the cargo box sidewall is composed of one or more gauges of steel making it structurally sufficient to accommodate the weight of a truck bed cap. The truck bed cap sits on one or more of these blocks that extend through the sidewall cap and is supported by the top surface of the cargo box sidewall. This allows the weight of the truck bed cap or accessory to be distributed through the blocks and onto the sidewalls rather than substantially on the sidewall caps.

Bolts or other fastening mechanisms may extend through the block and into the top of the cargo box sidewall to secure the truck bed cap onto same. Again, multiple support blocks may extend through, or underneath, the sidewall caps and sit on the cargo box sidewalls to support the weight of the truck bed cap without the sidewall caps having to.

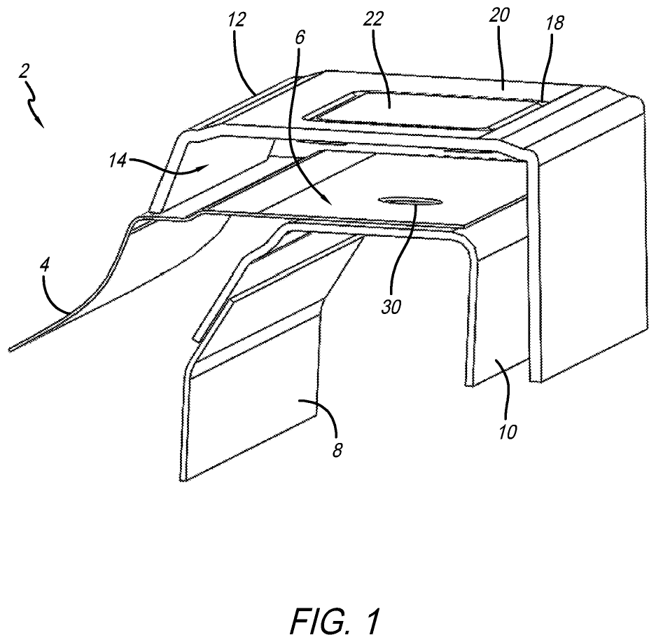

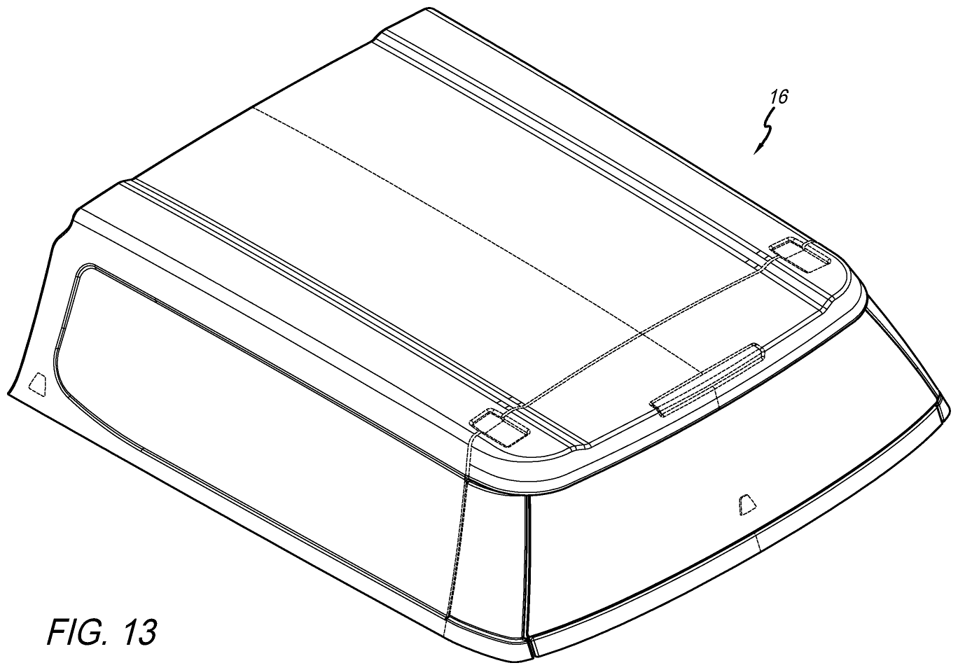

FIGS. 1, 2, 3, and 4 are various views of a portion of a cargo box sidewall 2. FIG. 1 is a perspective sectional detail view of a portion of cargo box sidewall 2. As shown, it is, illustratively, composed of an outer sheet 4 extending up to a top surface 6 of cargo box sidewall 2, an inner wall 8, and an inner sidewall rail 10. A bore 30 is also, illustratively, shown disposed through top surface 6 of cargo box sidewall 2, as well as through the top of inner rail 10. On top of cargo box sidewall 2 is a sidewall cap 12. In contrast to the other components of cargo box sidewall 2 shown herein, which are made of various gauges of formed steel sheets, sidewall cap 12 is often made of plastic or other like material. In this particular construction of cargo box sidewall 2, sidewall cap 12 is placed over top surface 6 of cargo box sidewall 2 with a gap 14 located therebetween. This assists in reducing the structural support sidewall cap 12 must offer since it is not further utilizing the strengths inherent in cargo box sidewall 2 itself. The result becomes an issue for certain heavy cargo box accessories, such as a truck bed cap, which, typically, covers the cargo box. Such an illustrative truck bed cap 16 is shown in FIG. 13.

In the embodiment of cargo box sidewall 2 shown, sidewall cap 12 includes a pocket 18 disposed through its top surface 20. In this view, a filler cap 22 is positioned over pocket 18. It is appreciated, however, that such pockets 18 can be formed on cargo box sidewall 2, as well as bores drilled through top surface 6 of cargo box sidewall 2 and/or sidewall cap 12, as needed. Filler cap 22 is a panel that is pre-scored to be removed from sidewall cap 12. Multiple filler caps 22 positioned along sidewall caps 12 are common features of pickup truck cargo boxes.

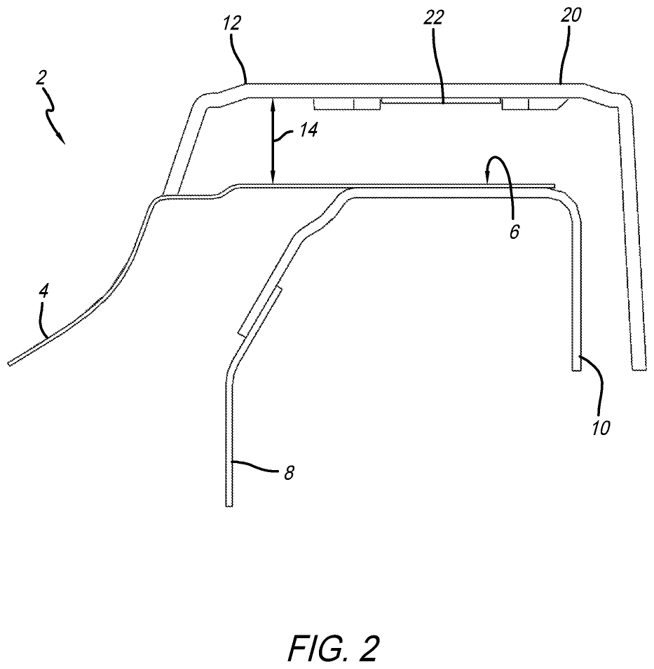

An end view of the portion of cargo box sidewall 2 shown in FIG. 1, is shown in FIG. 2. This view further demonstrates gap 14 that exists between the underside of sidewall cap 12 and top surface 6 of cargo box sidewall 2. If too much downward force is applied to sidewall cap 12, it may buckle or collapse into gap 14. Such lack of structural strength can be an issue for certain cargo box accessories, like truck bed cap 16 (see ,Fig. 13), that sits on the top of these cargo box sidewalls 2 and are intended to be supported by same.

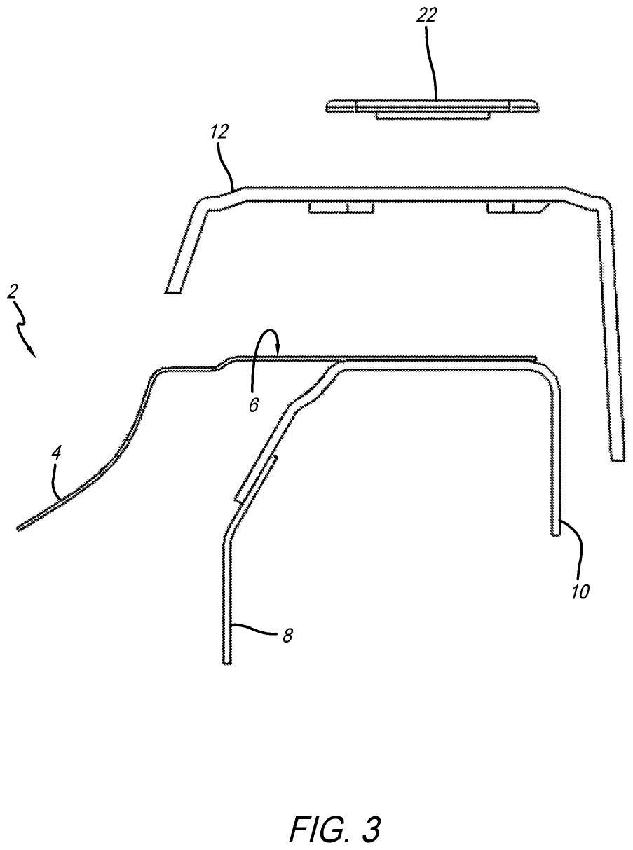

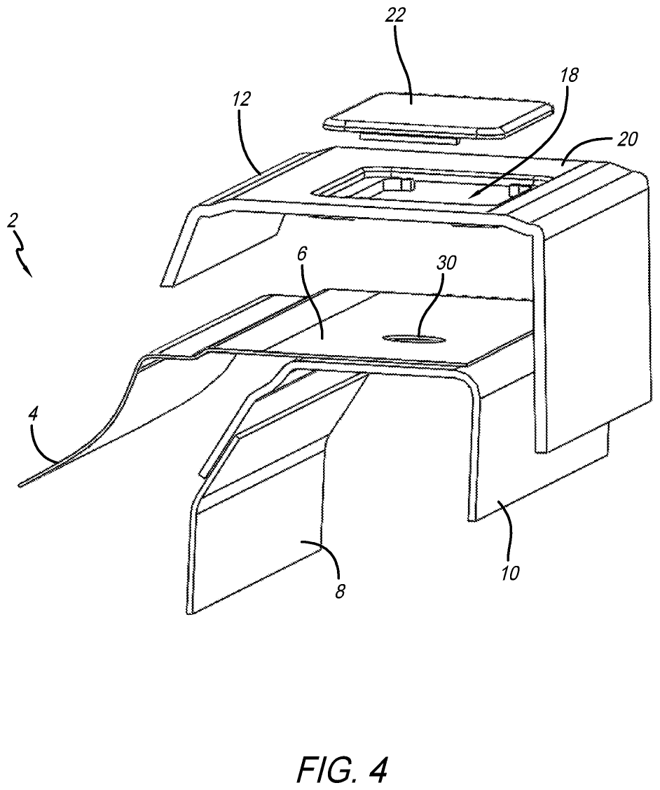

End and perspective exploded detail views of the portion of cargo box sidewall 2 from FIG. 1, are shown in FIGS. 3 and 4. These figures, along with the others, illustrate the type of cargo box sidewall 2 that may need reinforcement to support heavier cargo box accessories like the truck bed cap 16.

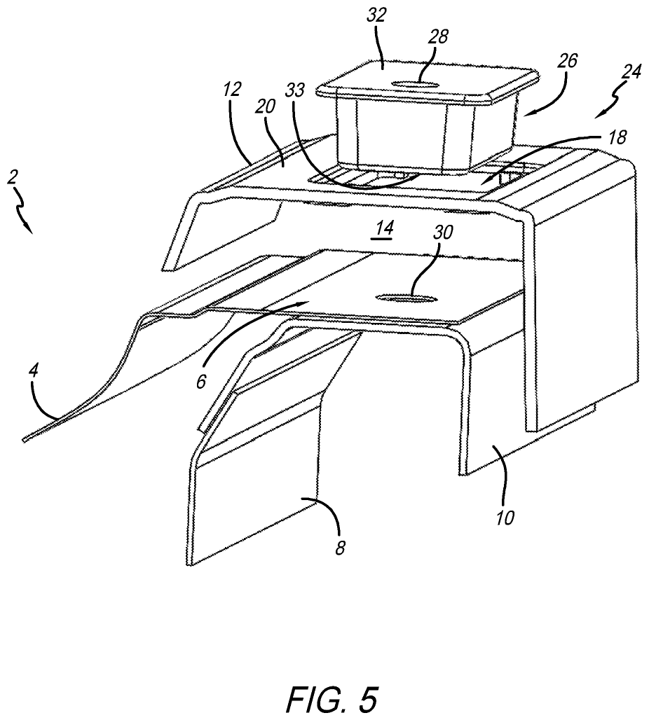

Illustrative embodiments of the present disclosure provide an accessory support mounting system 24 to provide the needed support for a truck bed cap or other like heavy accessory. A detail perspective view of a portion of cargo box sidewall 2 is shown in FIG. 5. In this view, a support block 26 is provided, which is sized to fit into pocket 18 of sidewall cap 12.

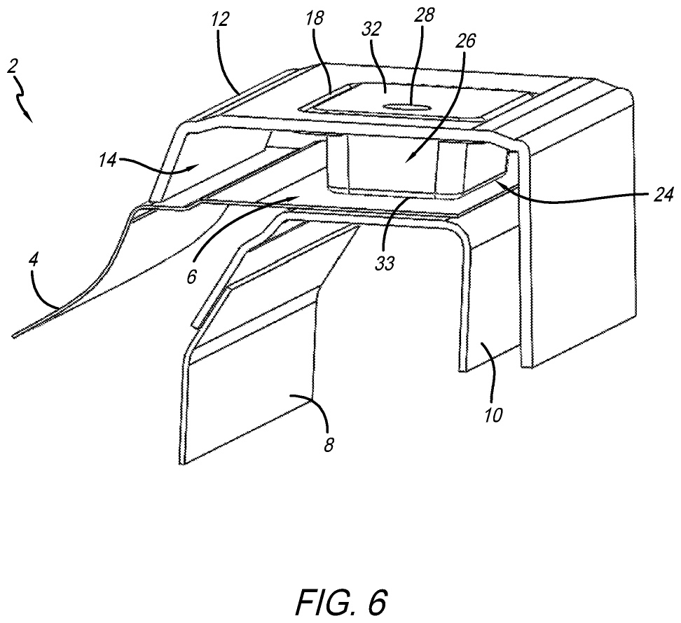

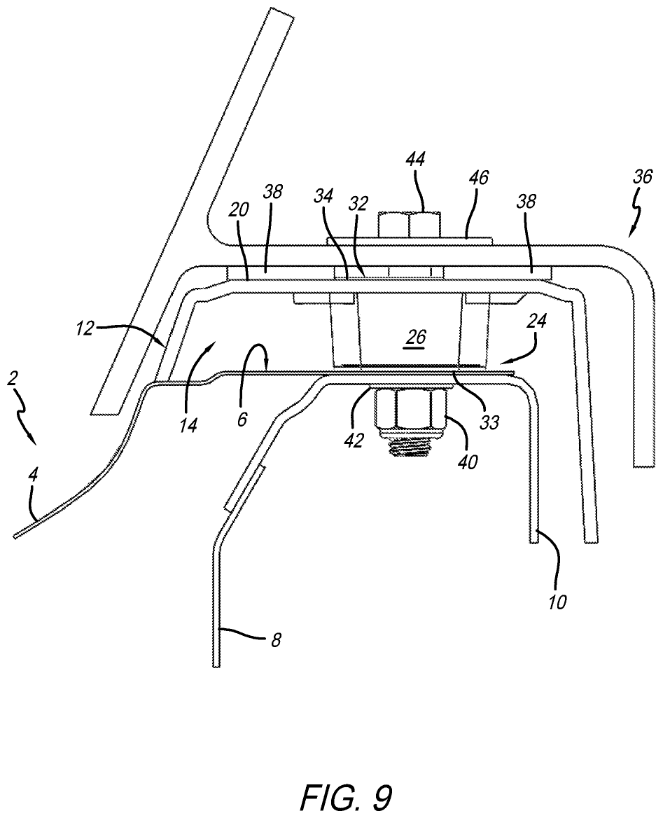

A detail perspective view of a portion of cargo box sidewall 2, shown in FIG. 6, depicts support block 26 fitted in pocket 18 of sidewall cap 12 and gap 14 underneath sidewall cap 12. Support block 26 is then supported by top surface 6 of cargo box sidewall 2. A bore 28 may be disposed through support block 26 and aligned with bore 30 disposed through top surface 6 of cargo box sidewall 2 to accommodate a bolt (see, FIG. 9) or other attaching device (see, FIG. 5). Block cap 32 is the top surface of support block 26. Block cap 32 may be any desired shape and is located opposite bottom surface 33 of support block 26. In this illustrative embodiment, block cap 32 shares a similar footprint profile as that of pocket 18 to fill a majority of the space created therein by the pocket being disposed through top surface 20 of sidewall cap 12.

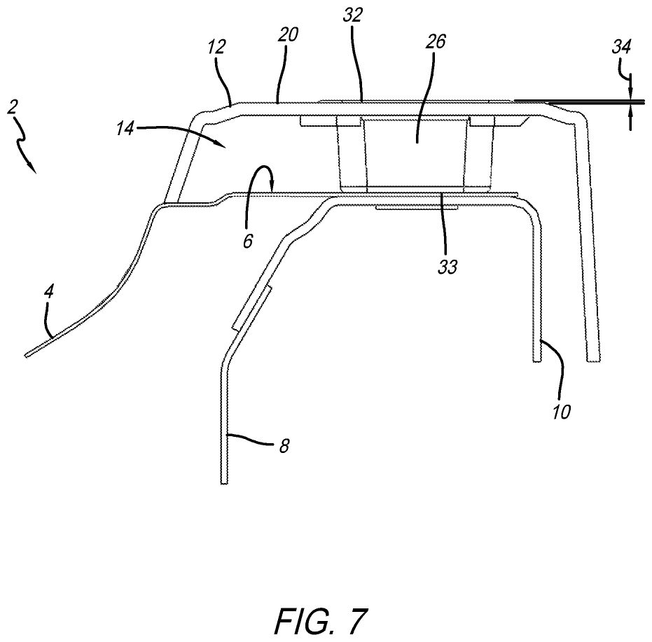

An end detail view of cargo box sidewall 2 shown in FIG. 7, depicts support block 26 in the same position as that shown in FIG. 6. The view in FIG. 7, however, further demonstrates how support block 26 is configured to support a truck bed cap or other structure that may be too heavy for sidewall cap 12. As shown herein, block cap 32 extends above top surface 20 of sidewall cap 12 a raised distance 34 so that a downward force applied by a truck bed cap 16, or other structure, is distributed through support block 26 via bottom surface 33, and ultimately cargo box sidewall 2, which, as shown, support block 26 sits on. This assists in keeping excess weight off of sidewall cap 12.

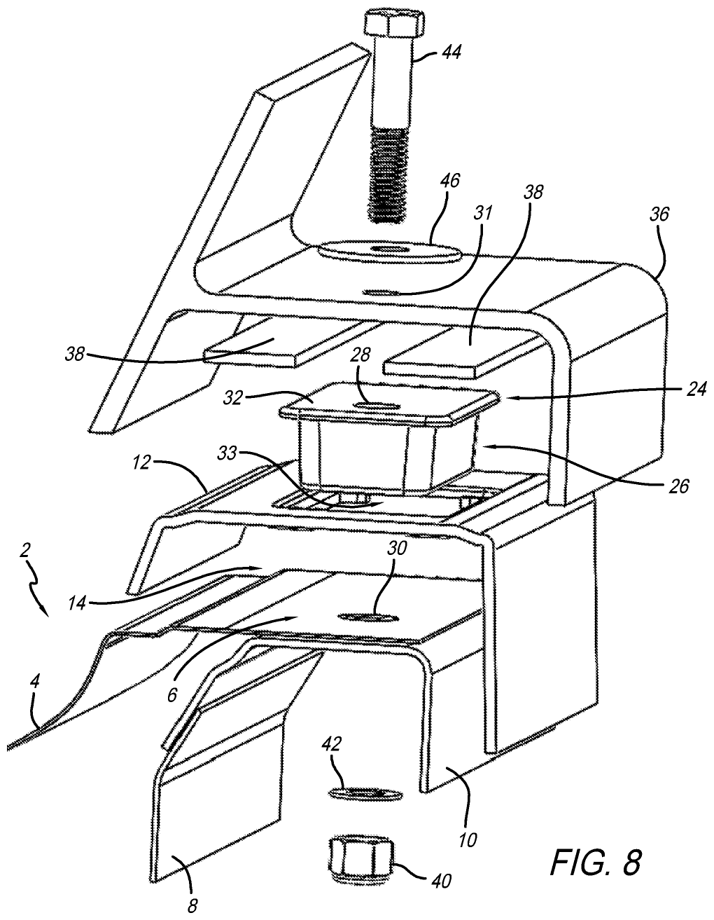

A perspective exploded detail view of a portion of cargo box sidewall 2 and accessory support mounting system 24 is shown in FIG. 8. This view depicts the makeup of cargo box sidewall 2, illustratively, composed of outer sheet 4, inner wall 8, inner sidewall rail 10, and sidewall cap 12. Likewise, accessory support mounting system 24 is shown including support block 26 with illustrative seals 38 positioned on opposing sides of bore 30 disposed through support block 26. A truck bed cap mount portion 36 is shown securable to cargo box sidewall 2 via a fastener such as bolt 44 extending through washer 46, through bore 31 of truck bed cap mount portion 36, through support block 26 via bore 28, and into bore 30 of top surface 6 of cargo box sidewall 2 and inner sidewall rail 10.

An end view shown in FIG. 9 depicts truck bed cap mount portion 36 positioned on top of sidewall cap 12 with seals 38 located therebetween. Washer 42 and nut 40 are assembled onto bolt 44 under top surface 6 of cargo box sidewall 2 with support block 26 sitting thereon and extending a raised distance 34 above the sidewall. A second washer 46 is, illustratively, positioned between the head of bolt 44 and truck bed cap mount portion 36.

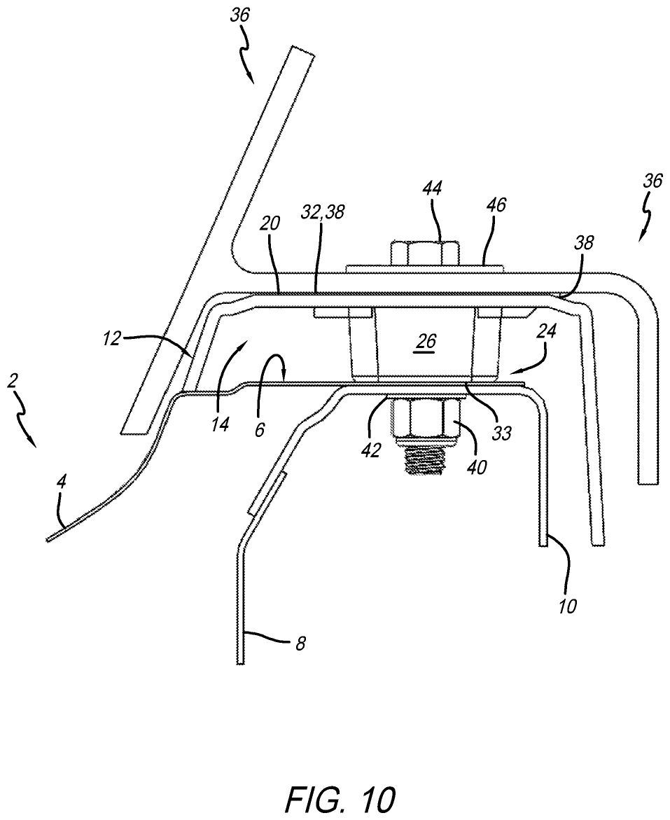

A similar view shown in FIG. 10 depicts nut 40 drawing truck bed cap mount portion 36 tighter against support block 26 for securing truck bed cap 16 (see, FIG. 13) to cargo box sidewall 2. It is appreciated that seals 38 are compressed between top surface 20 of sidewall cap 12 and the underside of truck bed cap mount portion 36. It is further appreciated that truck bed cap mount portion 36 is supported by block cap 32 on support block 26 and, ultimately, cargo box sidewall 2 rather than sidewall cap 12. It is further appreciated that multiple support blocks 26 in this and similar configurations may be employed along the length of cargo box sidewall 2, as well as an opposing cargo box sidewall 2, to provide the needed support for truck bed cap 16 without applying undue force on sidewall cap 12 and risking possible damage to same.

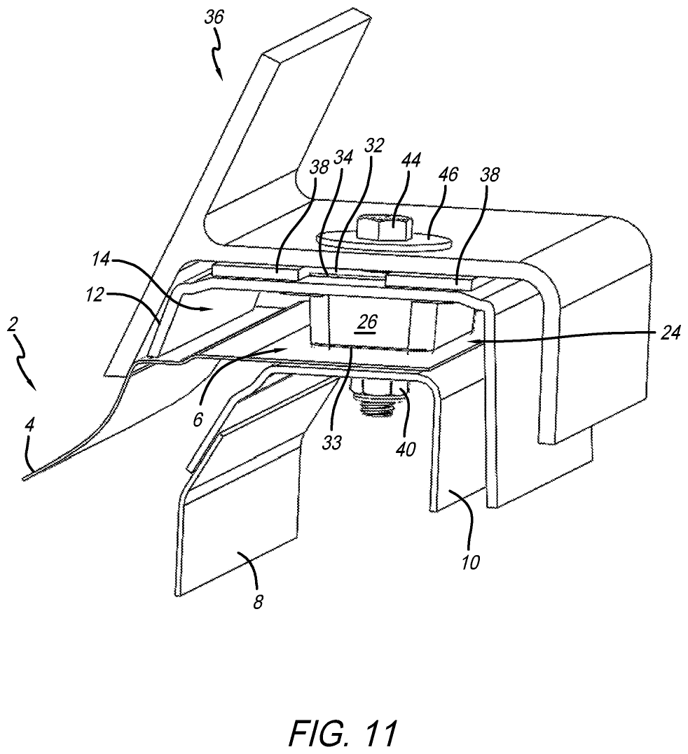

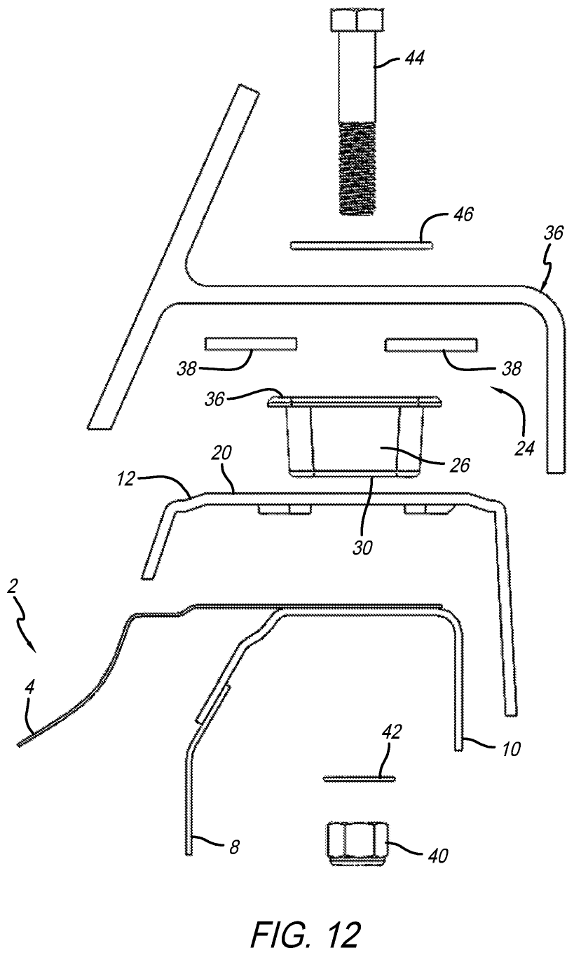

A perspective end detail view of cargo box sidewall 2 in FIG. 11 shows the truck bed cap mount portion 36 being positioned over sidewall cap 12 and nut 40 preparing to secure truck bed cap mount portion 36 further onto bolt 44 for attaching truck bed cap 16 (see FIG. 13) onto cargo box sidewall 2. The exploded end view shown in FIG. 12 illustrates the various components employed to secure truck bed cap mount portion 36 onto the cargo box sidewall cap 12 as discussed in the previous views. The perspective view of FIG. 13 depicts an illustrative truck bed cap 16 that can be mounted on to accessory mounting system 24 so as not to be supported by sidewall cap 12, which may not be able to hold the weight.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. An accessory mounting system to support an accessory on a truck bed sidewall, the accessory mounting system comprising:
at least one support block configured to be positioned within a pocket in a sidewall cap of the truck bed sidewall and extend from a top surface of the truck bed sidewall located under the sidewall cap;
wherein the at least one support block includes a top surface configured to support the accessory and a bottom surface configured to be supported by the truck bed sidewall;
wherein the top surface of the at least one support block is configured to extend above a top surface of the sidewall cap to create a gap between the accessory and the top surface of the sidewall cap so the accessory is configured to be supported by the at least one support block and not the sidewall cap;
wherein a bore disposed through the at least one support block; and
a fastener;
wherein the bore is configured to receive the fastener to secure the at least one support block to the top surface of the truck bed sidewall.

2. The accessory mounting system of claim 1, wherein the at least one support block includes a plurality of support blocks, wherein each of the plurality of support blocks is configured to be positioned in one pocket.

3. The accessory mounting system of claim 2, wherein the each of the plurality of support blocks includes a top surface configured to support the accessory and a bottom surface configured to be supported by the truck bed sidewall.

4. The accessory mounting system of claim 2, wherein the each of the plurality of support blocks includes a top surface configured to support the accessory and a bottom surface configured to be supported by the truck bed sidewall or by a second truck bed sidewall spaced apart from the truck bed sidewall.

5. The accessory mounting system of claim 3, wherein the each of the plurality of support blocks is configured to extend above the top surface of the sidewall cap to create a gap between the accessory and the top surface of the sidewall cap so the accessory is configured to be supported by the each of the plurality of support blocks and not the sidewall cap.

6. The accessory mounting system of claim 4, wherein the each of the plurality of support blocks is configured to extend above the top surface of the sidewall cap of the truck bed sidewall or above a second sidewall cap of the second truck bed sidewall to create a gap between the accessory and the top surface of the sidewall cap or a top surface of the second sidewall cap so the accessory is configured to be supported by the each of the plurality of support blocks and not by the sidewall cap or the second sidewall cap.

7. The accessory mounting system of claim 2, wherein the each of the plurality of support blocks includes a bore disposed therethrough.

8. The accessory mounting system of claim 7, wherein the each of the plurality of support blocks receives a fastener to secure the each of the plurality of support blocks to the truck bed sidewall.

9. The accessory mounting system of claim 1, further comprising at least one seal configured to be positioned in the gap between the accessory and the top surface of the sidewall cap.

10. The accessory mounting system of claim 9, wherein the at least one seal includes a plurality of seals.

11. The accessory mounting system of claim 9, wherein the fastener is a bolt.

12. An accessory mounting system to support an accessory on a truck bed sidewall, the accessory mounting system comprising:
at least one support block configured to be positioned within a pocket in a sidewall cap of the truck bed sidewall and extend from a top surface of the truck bed sidewall located under the sidewall cap; and
wherein the at least one support block includes a top surface configured to support the accessory and a bottom surface configured to be supported by the truck bed sidewall.

13. The accessory mounting system of claim 12, wherein the top surface of the at least one support block is configured to extend above a top surface of the sidewall cap to create a gap between the accessory and the top surface of the sidewall cap.

14. The accessory mounting system of claim 12, wherein a bore is disposed through the at least one support block.

15. The accessory mounting system of claim 14, further comprising a fastener, wherein the bore is configured to receive the fastener to secure the at least one support block to the truck bed sidewall.

16. The accessory mounting system of claim 15, wherein the fastener is a bolt.

17. The accessory mounting system of claim 12, wherein the at least one support block includes a plurality of support blocks, wherein each of the plurality of support blocks is configured to be positioned in one pocket.

18. The accessory mounting system of claim 17, wherein the each of the plurality of support blocks includes a top surface configured to support the accessory and a bottom surface configured to be supported by the truck bed sidewall.
